(19) United States
(12) Patent Application Publication
(10) Pub. No.: US 2010/0060541 A1
(43) Pub. Date: Mar. 11, 2010

(54) ANTENNA

(75) Inventors: Jr-Ren Jeng, Taipei City (TW); Chau-Min Yang, Yunlin County (TW)

Correspondence Address: APEX JURIS, PLLC, 12733 LAKE CITY WAY NORTHEAST, SEATTLE, WA, 98125, US

(73) Assignee: SmartAnt Telecom Co., LTd., Hsinchu County (TW)

(21) Appl. No.: 12/206,342

(22) Filed: Sep. 8, 2008

(51) Int. Cl. H01Q 9/16

(52) U.S. Cl. 343/795

(57) ABSTRACT

An antenna includes a substrate, a radiation portion, and a signal feed-in portion. The radiation portion includes a first radiation unit and a second radiation unit. The first radiation unit and the second radiation unit are disposed on the same surface of the substrate. The signal feed-in portion is disposed on the first radiation unit. The second radiation unit and the first radiation unit have the same shape and are symmetrical in position, and the second radiation unit is connected to the first radiation unit, such that the first radiation unit and the second radiation unit form a closed loop. Thus, the impedance is improved and a wider bandwidth is achieved.

### BACKGROUND OF THE INVENTION

1. Field of Invention

The present invention relates to an antenna, in particular, to an antenna having a high impedance and a wider bandwidth.

2. Related Art

Along with the development of wireless communication technology, the user may use the wireless communication system to transmit information anywhere. Antenna is an important component in the field of wireless communication. Currently, the PCB method having the advantages of easy fabricating processes and low cost is favored by the antenna manufacturers.

Referring to FIGS. 1A and 1B, FIGS. 1A and 1B are schematic views of a conventional omnidirectional antenna. FIG. 1A is a schematic front view of the conventional omnidirectional antenna, and FIG. 1B is a schematic back view of the conventional omnidirectional antenna. The omnidirectional antenna has a substrate 1, a signal feed-in portion 2, a first circuit 3, a second circuit 4, a first radiation portion 5, and a second radiation portion 6. The second radiation portion 6 is a ground portion.

The conventional omnidirectional antenna has a relative low gain. In order to increase the gain, the open dipole antenna is formed in a manner of serial connection. However, in order to achieve the impedance matching between the radiation units or the ground units connected in series, a wider metal wire may be fabricated in the circuit of the open-circuit dipole antenna to transmit a signal. The wider metal wire reduces a distance between the metal wire and a radiation end of the radiation unit, such that the signal transmitted on the metal wire may affect the signal in the radiation end, which causes a coupling effect between the metal wire and the radiation end.

The coupling effect between the metal wire and the radiation end not only influences the impedance matching between the radiation units, but also causes the limitation to the bandwidth. On the other hand, if the distance between the metal wire and the radiation end is enhanced to avoid the coupling effect between the metal wire and the radiation end, the directivity of the omnidirectional antenna may be overly high.

In order to avoid the problem of the conventional omnidirectional antenna, the connection point of the first radiation unit and the connection point of the second radiation unit are connected in series to the first radiation unit and the second radiation unit by drilling and welding, so as to form a circular loop. By the use of the high impedance characteristic of the dipole antenna having the circular antenna radiation unit, a larger bandwidth than the conventional antenna may be achieved. However, in order to connect the first radiation unit and the second radiation unit, the process difficulty is increased and the yield is reduced accordingly.

The relevant patent is ROC Patent No. M329254.

### SUMMARY OF THE INVENTION

Accordingly, the present invention is directed to an antenna, which forms a closed loop by connecting radiation portions and a ground portion. The circular dipole antenna having a high impedance characteristic may realize a wider bandwidth effect as well as decreasing the process difficulty and improving the yield.

The antenna disclosed in the present invention includes a substrate, a radiation portion, and a signal feed-in portion. The radiation portion includes a first radiation unit and a second radiation unit. The first radiation unit and the second radiation unit are disposed on the same surface of the substrate. The signal feed-in portion is disposed on the first radiation unit. The second radiation unit and the first radiation unit have the same shape and are symmetrical in position, and the second radiation unit is connected to the first radiation unit, such that the first radiation unit and the second radiation unit form a closed loop. Here, the second radiation unit is a ground unit of the antenna, for feeding in/out a signal through the signal feed-in portion.

Another antenna disclosed in the present invention includes a substrate, a main signal feed-in portion, a plurality of radiation portions, and a sub-signal feed-in portion. The substrate has a first surface and a second surface, the first surface has a first circuit, and the second surface has a second circuit overlapping the first circuit. The main signal feed-in portion is located on the first circuit and the second circuit, for feeding in/out a signal. Each radiation portion includes a first radiation unit and a second radiation unit. The first radiation unit and the second radiation unit are located on the first surface, and the first radiation unit is electrically connected to the first circuit. The second radiation unit and the first radiation unit of the same radiation portion have the same shape and are symmetrical in position, and the second radiation unit is connected to the first radiation unit, such that the first radiation unit and the second radiation unit form a closed loop. The second radiation unit is a ground unit of the antenna. The sub-signal feed-in portion is located on the second circuit and the first radiation unit for feeding in/out a signal.

The antenna disclosed in the present invention feeds in signals through the main signal feed-in portion and the sub-signal feed-in portion, and transmits the signals to the radiation portions through the first circuit and the second circuit. The pin of the first radiation unit is connected to the pin of the second radiation unit to form a circular closed loop, thereby achieving a high impedance characteristic and a wider bandwidth effect, as well as decreasing the process difficulty and improving the yield.

### BRIEF DESCRIPTION OF THE DRAWINGS

The present invention will become more fully understood from the detailed description given herein below for illustration only, and thus are not limitative of the present invention, and wherein:

FIG. 1A is a schematic view of a first surface of a conventional omnidirectional antenna;

FIG. 1B is a schematic view of a second surface of a conventional omnidirectional antenna;

FIG. 2 is a schematic view of a first embodiment of the present invention;

FIG. 3A is a schematic view of a first surface according to a second embodiment of the present invention;

FIG. 3B is a schematic view of a second surface according to the second embodiment of the present invention;

FIG. 4 is a measurement diagram of a standing wave ratio (SWR) according to the second embodiment of the present invention;

FIG. 5A is a field pattern of a central polarization of a horizontal plane obtained at a frequency of 1710 MHz according to the second embodiment of the present invention;

FIG. 5B is a field pattern of a central polarization of a horizontal plane obtained at a frequency of 1825 MHz according to the second embodiment of the present invention;

FIG. 5C is a field pattern of a central polarization of a horizontal plane obtained at a frequency of 1940 MHz according to the second embodiment of the present invention;

FIG. 5D is a field pattern of a central polarization of a horizontal plane obtained at a frequency of 2055 MHz according to the second embodiment of the present invention;

FIG. 5E is a field pattern of a central polarization of a horizontal plane obtained at a frequency of 2170 MHz according to the second embodiment of the present invention;

FIG. 6A is a field pattern of a central polarization of a vertical plane obtained at a frequency of 1710 MHz according to the second embodiment of the present invention;

FIG. 6B is a field pattern of a central polarization of a vertical plane obtained at a frequency of 1825 MHz according to the second embodiment of the present invention;

FIG. 6C is a field pattern of a central polarization of a vertical plane obtained at a frequency of 1940 MHz according to the second embodiment of the present invention;

FIG. 6D is a field pattern of a central polarization of a vertical plane obtained at a frequency of 2055 MHz according to the second embodiment of the present invention; and

FIG. 6E is a field pattern of a central polarization of a vertical plane obtained at a frequency of 2170 MHz according to the second embodiment of the present invention.

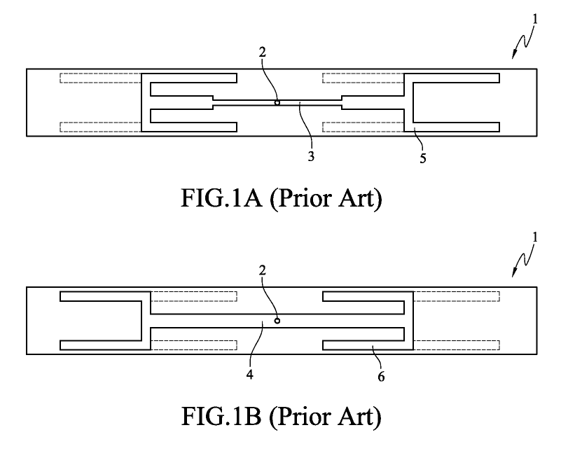

### DETAILED DESCRIPTION OF THE INVENTION

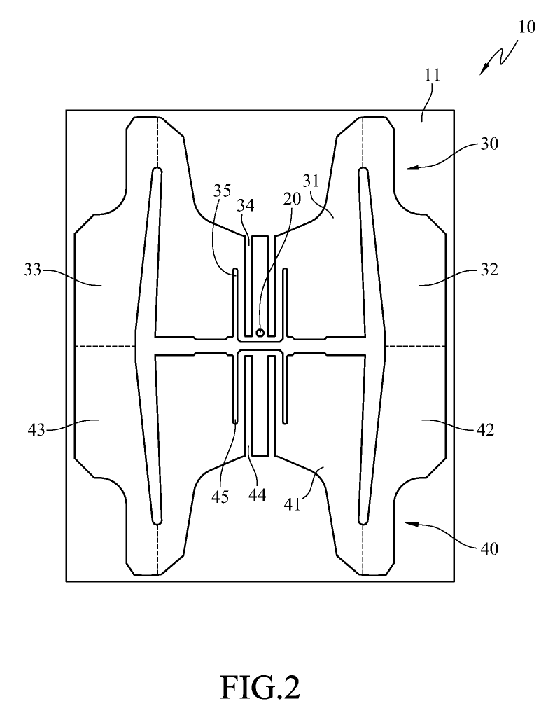

FIG. 2 is a schematic view according to a first embodiment of the present invention. As shown in FIG. 2, the antenna includes a substrate 10, a signal feed-in portion 20, and a radiation portion.

The substrate 10 has a surface 11. The radiation portion includes a first radiation unit 30 and a second radiation unit 40. The first radiation unit 30 and the second radiation unit 40 are disposed on the surface 11, and the second radiation unit 40 is used as a ground unit of the antenna. The second radiation unit 40 is connected to the first radiation unit 30, such that the first radiation unit 30 and the second radiation unit 40 form a circular closed loop. The signal feed-in portion 20 is disposed on the first radiation unit 30, for feeding in/out a signal of a predetermined frequency band.

The first radiation unit 30 has a body 31 and a first extension portion 32 and a second extension portion 33 extending from two sides of the body 31. The second radiation unit 40 has a body 41 and a third extension portion 42 and a fourth extension portion 43 extending from two sides of the body 41. The first extension portion 32 is connected to the third extension portion 42, and the second extension portion 33 is connected to the fourth extension portion 43, such that the first radiation unit 30 and the second radiation unit 40 form a circular closed loop.

The first radiation unit 30 may further have a plurality of first grooves for inhibiting an impact of current leakage on the first radiation unit 30. The second radiation unit 40 may also have a plurality of second grooves, for inhibiting an impact of current leakage on the second radiation unit 40.

Here, the second grooves and the first grooves may have the same shape and are symmetrical in position. Definitely, the second grooves and the first grooves may have different shapes and are asymmetrical in position.

In this embodiment, the body 31 of the first radiation unit 30 may have first grooves 34 and 35. Herein, the first grooves 34 and 35 are arranged in parallel.

The opening of the first groove 34 is located on the other side of the body 31 of the first radiation unit 30 relative to the second radiation unit 40 (i.e., the outer side of the body 31 of the first radiation unit 30), and the first groove 34 extends from the outer side of the body 31 of the first radiation unit 30 to the second radiation unit 40. The first groove 34 may extend in a direction corresponding to a smallest distance between the outer side of the body 31 of the first radiation unit 30 and the second radiation unit 40. The opening of the first groove 35 is located on one side of the body 31 of the first radiation unit 30 close to the second radiation unit 40 (i.e., the inner side of the body 31 of the first radiation unit 30), and the first groove 35 extends from the inner side of the body 31 of the first radiation unit 30 to be away from the second radiation unit 40. Here, the first groove 35 may extend in parallel in an opposite direction to an extension direction of the first groove 34.

In this embodiment, the body 41 of the second radiation unit 40 may be formed with second grooves 44 and 45. Here, the first grooves 44 and 45 are arranged in parallel.

The opening of the second groove 44 is located on the other side of the body 41 of the second radiation unit 40 relative to the first radiation unit 30 (i.e., the outer side of the body 41 of the second radiation unit 40), and the second groove 44 extends from the outer side of the body 41 of the second radiation unit 40 to the first radiation unit 30. The second groove 44 may extend in a direction of a smallest distance between the outer side of the body 41 of the second radiation unit 40 and the first radiation unit 30. The opening of the second groove 45 is located on one side of the body 41 of the second radiation unit 40 close to the first radiation unit 30 (i.e., the inner side of the body 41 of the second radiation unit 40), and the second groove 45 extends from the inner side of the body 41 of the second radiation unit 40 to be away from the first radiation unit 30. Here, the first groove 45 may extend in parallel in a direction opposite to the extension direction of the second groove 44.

This embodiment further includes a signal line (not shown). The signal line includes a core, an insulating layer, and a metal ground layer. The insulating layer is warped on the core, and the metal ground layer is warped on the insulating layer. The core is electrically connected to the signal feed-in portion 20, and the metal ground layer is connected to the second radiation unit 40. The core is used to transmit a signal of a predetermined frequency band. The insulating layer is used to isolate the core from the outside. The metal ground layer is used to prevent the external electromagnetic signal from affecting the signal transmitted on the core, and the metal ground layer is capable of grounding the signal.

The substrate 10 is usually a PCB or other types. And, the substrate 10 may be a rigid plate or a flexible soft plate. The rigid plate may be made of fiberglass or other materials such as bakelite, and the flexible soft plate may be made of polyimide (PI) or other materials such as polyethylene terephthalate (PET).

The signal feed-in portion 20 may penetrate the substrate 10 from the first radiation unit 30 on the surface 11 of the substrate 10 to a hole on another surface of the substrate 10.

The first radiation unit 30 may be M-shaped, or a geometrical shape such as rectangular or finger shape. The second radiation unit 40 and the first radiation unit 30 may have the same shape and are symmetrical in position. Definitely, the second radiation unit 40 and the first radiation unit 30 may have different shapes and are asymmetrical in position.

When a signal of a specific frequency band is transmitted to a signal feed-in portion 20 via the core of the signal line, then fed into the first radiation unit 30 via the signal feed-in portion 20, the first radiation unit 30 may receive and radiate the above signal. Here, the first radiation unit 30 and the second radiation unit 40 are connected to form a circular closed loop. Therefore, the signal of the frequency band transmitted on the first radiation unit 30 may be transmitted to the second radiation unit 40 through the connection between the first extension portion 32 and the third extension portion 42 and the connection between the second extension portion 33 and the fourth extension portion 43, and thus the second radiation unit 40 may receive and radiate the above signal. Also, the design of the first grooves 34 and 35 and the second grooves 44 and 45 may inhibit the impact of current leakage on the first radiation unit 30 and the second radiation unit 40 when the above-mentioned signal of the frequency band is transmitted.

In the antenna of this embodiment, the first radiation unit and the second radiation unit are connected to form a circular closed loop, so as to achieve the high impedance characteristic and the wider bandwidth effect, as well as decreasing the process difficulty and improving the yield.

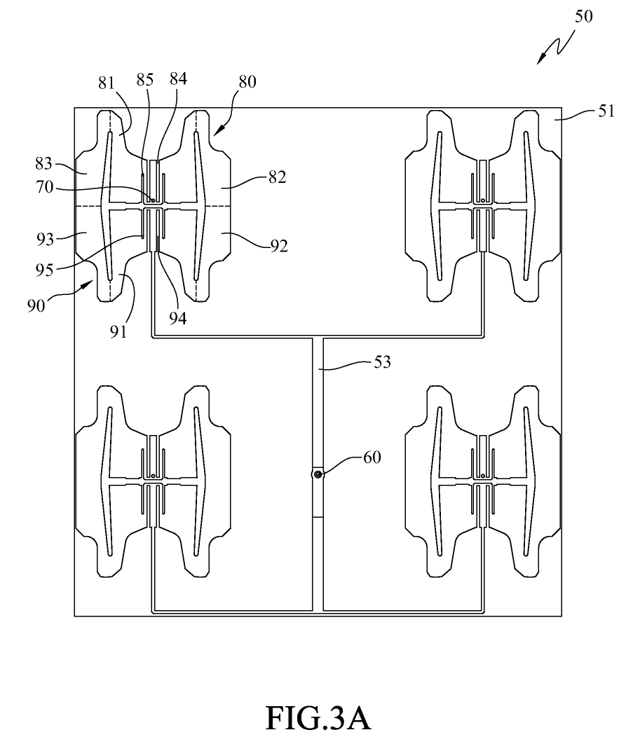

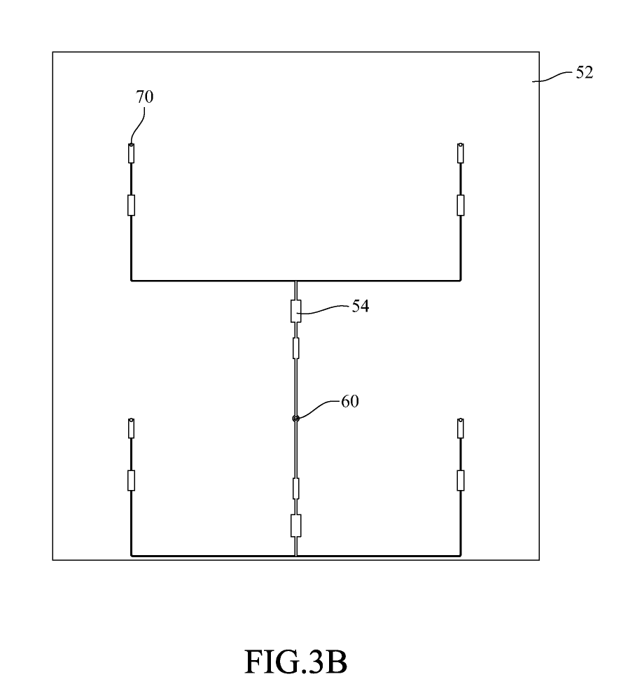

Referring to FIGS. 3A and 3B, FIGS. 3A and 3B are schematic views according to the second embodiment of the present invention. FIG. 3A is a schematic view of a first surface according to a second embodiment of the present invention, and FIG. 3B is a schematic view of a second surface according to the second embodiment of the present invention. As shown in FIGS. 3A and 3B, the antenna in this embodiment includes a substrate 50, a main signal feed-in portion 60, a plurality of sub-signal feed-in portions 70, and a plurality of radiation portions.

The substrate 50 has a first surface 51 and a second surface 52. The first surface 51 has a first circuit 53, and the second surface 52 has a second circuit 54 overlapping the first circuit 53.

The main signal feed-in portion 60 is located on the first circuit 53 and the second circuit 54.

Each radiation portion includes a first radiation unit 80 and a second radiation unit 90. The first radiation unit 80 and the second radiation unit 90 are disposed on the first surface 51. The second radiation unit 90 is electrically connected to the first circuit 53 and serves as a ground unit of the antenna. The second radiation unit 90 and the first radiation unit 80 have the same shape and are symmetrical in position, and the second radiation unit 90 and the first radiation unit 80 are connected so as to form a closed loop.

The sub-signal feed-in portions 70 are located on the second circuit 54 and the first radiation unit 80.

The first radiation unit 80 may have a body 81 and a first extension portion 82 and a second extension portion 83 extending from two sides of the body 81. The second radiation unit 90 may have a body 91 and a third extension portion 92 and a fourth extension portion 93 extending from the body 91. The first extension portion 82 is connected to the third extension portion 92, and the second extension portion 83 is connected to the fourth extension portion 93, such that the first radiation unit 80 and the second radiation unit 90 form a circular closed loop.

The first radiation unit 80 may further have a plurality of first grooves for inhibiting the impact of current leakage on the first radiation unit 80. The second radiation unit 90 has a plurality of second grooves for inhibiting the impact of current leakage on the second radiation unit 90. The second grooves and the first grooves may have the same shape and are symmetrical in position. Definitely, the second grooves and the first grooves may have different shapes and are asymmetrical in position.

In this embodiment, the body 81 of the first radiation unit 80 may have first grooves 84 and 85. Herein, the first grooves 84 and 85 are arranged in parallel.

The opening of the first groove 84 is located on the other side of the body 81 of the first radiation unit 80 relative to the second radiation unit 90 (i.e., the outer side of the body 81 of the first radiation unit 80), and the first groove 84 extends from the outer side of the body 81 of the first radiation unit 80 to the second radiation unit 90. The first groove 84 may extend in a direction of a smallest distance between the outer side of the body 81 of the first radiation unit 80 and the second radiation unit 90. The opening of the first groove 85 is located on one side of the body 81 of the first radiation unit 80 close to the second radiation unit 90 (i.e., the inner side of the body 81 of the first radiation unit 80), and the first groove 85 extends from the inner side of the body 81 of the first radiation unit 80 to be away from the second radiation unit 90. Here, the first groove 85 may extend in parallel in a direction opposite to the extension direction of the first groove 84.

In this embodiment, the body 91 of the second radiation unit 90 has second grooves 94 and 95. Here, the second grooves 94 and 95 are arranged in parallel.

The opening of the second groove 94 is located on the other side of the body 91 of the second radiation unit 90 relative to the first radiation unit 80 (i.e., the outer side of the body 91 of the second radiation unit 90), and the second groove 94 extends from the outer side of the body 91 of the second radiation unit 90 to the first radiation unit 80. The second groove 94 may extend in a direction of a smallest distance between the outer side of the body 91 of the second radiation unit 90 and the first radiation unit 80. The opening of the second groove 95 is located on one side of the body 91 of the second radiation unit 90 close to the first radiation unit 80 (i.e., the inner side of the body 91 of the second radiation unit 90), and the second groove 95 extends from the inner side of the body 91 of the second radiation unit 90 to be away from the first radiation unit 80. Here, the first groove 95 may extend in parallel in a direction opposite to the extension direction of the second groove 94.

This embodiment further includes a signal line (not shown). The signal line includes a core, an insulating layer, and a metal ground layer. The insulating layer is warped on the core, and the metal ground layer is warped on the insulating layer. The core is electrically connected to the main signal feed-in portion 60, and the metal ground layer is connected to the second radiation unit 40. The core is used to transmit a signal of a predetermined frequency band. The insulating layer is used to isolate the core from the outside. The metal ground layer is used to prevent the external electromagnetic signal from affecting the signal transmitted on the core, and the metal ground layer is capable of grounding the signal.

The substrate 50 is usually a PCB, or other types. And, the substrate 50 may be a rigid plate or a flexible soft plate. The rigid plate may be made of fiberglass or other materials such as bakelite, and the flexible soft plate may be made of polyimide (PI) or other materials such as polyethylene terephthalate (PET).

The main signal feed-in portion 60 may penetrate the substrate 50 from the first circuit 53 on the surface 51 of the substrate 50 to a hole of the second circuit 54 of the second surface 52.

The sub-signal feed-in portion 70 may penetrate the substrate 50 from the first radiation unit 80 to a hole of the second circuit 54 of the second surface 52 of the substrate 50.

The first radiation unit 80 may be M-shaped, or a geometrical shape such as rectangular or finger shape. The second radiation unit 90 and the first radiation unit 80 may have the same shape and are symmetrical in position. Definitely, the second radiation unit 90 and the first radiation unit 80 may have different shapes and are asymmetrical in position.

When a signal of a specific frequency band is transmitted to a second circuit 54 of the second surface 52 via the main signal feed-in portion 60, then fed the signal of the frequency band into the first radiation unit 80 via the sub-signal feed-in portion 70, the first radiation unit 80 may receive and radiate the above signal of the frequency band. The first radiation unit 80 and the second radiation unit 90 are connected to form a circular closed loop. Therefore, the signal of the frequency band transmitted in the first radiation unit 80 may be transmitted to the second radiation unit 90 through the connection between the first extension portion 82 and the third extension portion 92 and the connection between the second extension portion 93 and the fourth extension portion 93, and thus the second radiation unit 90 may receive and radiate the above signal. Also, the design of the first grooves 84 and 85 and the second grooves 94 and 95 may inhibit the impact of current leakage on the first radiation unit 80 and the second radiation unit 90 when the above-mentioned signal of the frequency band is transmitted.

In the antenna of this embodiment, the first radiation unit and the second radiation unit are connected to form a circular closed loop, so as to achieve the high impedance characteristic and the wider bandwidth effect, as well as decreasing the process difficulty and improving the yield.

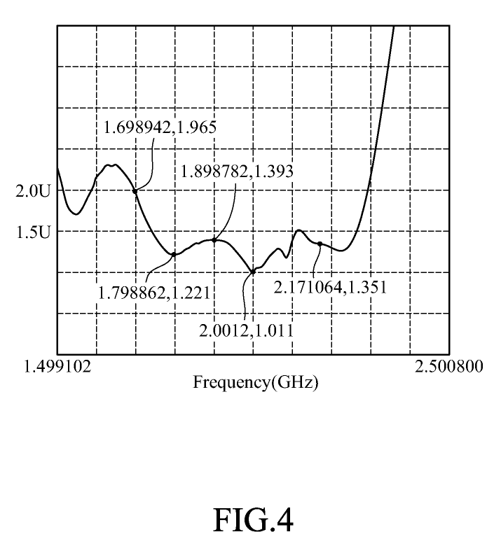

Referring to FIG. 4, FIG. 4 is a measurement diagram of a standing wave ratio (SWR) according to the second embodiment of the present invention. It is seen that the SWR value in a frequency range 1710 MHz-2170 MHz is maintained below 2.

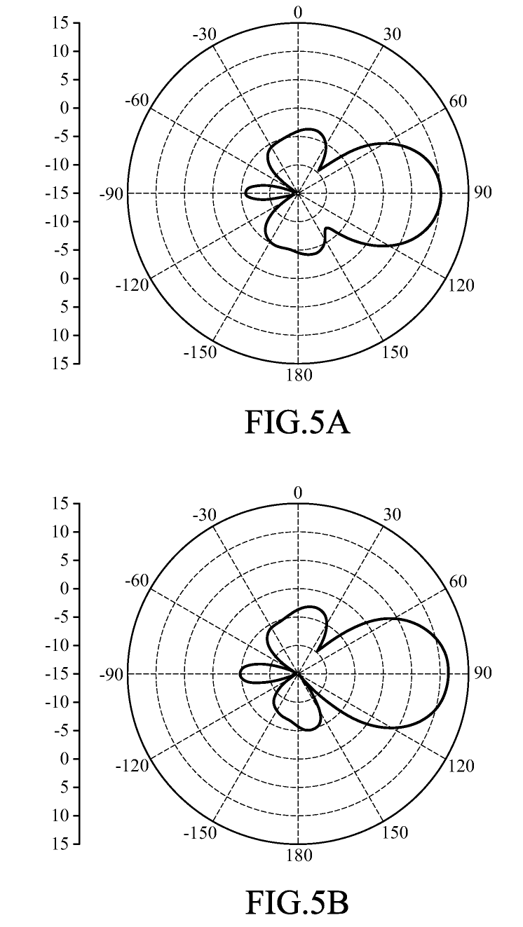

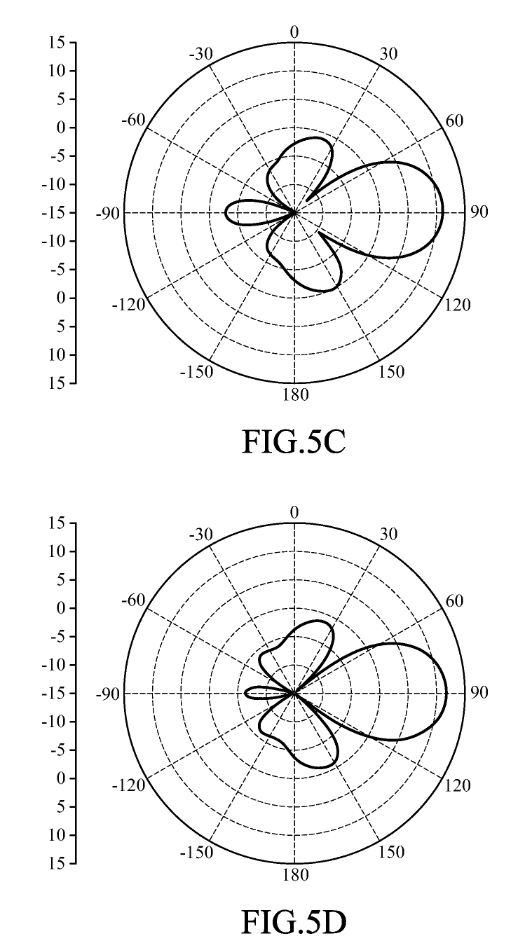

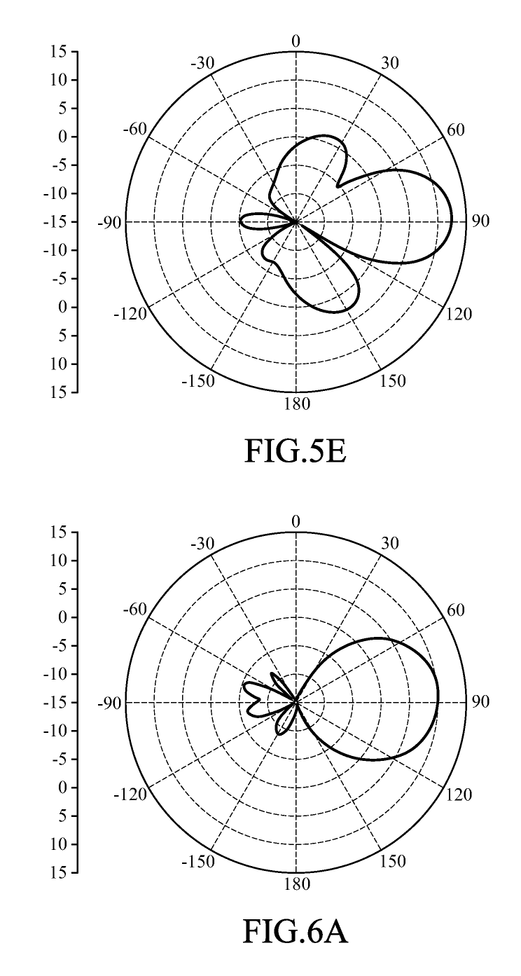

FIGS. 5A, 5B, 5C, 5D, and 5E are field patterns of a central polarization of a horizontal plane respectively obtained at frequency values 1710 MHz, 1825 MHz, 1940 MHz, 2055 MHz, and 2170 MHz according to the second embodiment of the present invention.

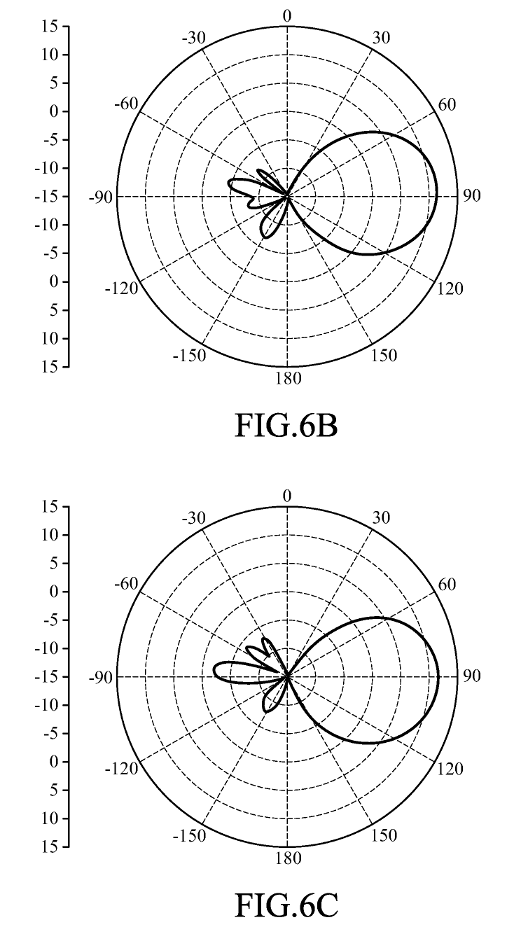

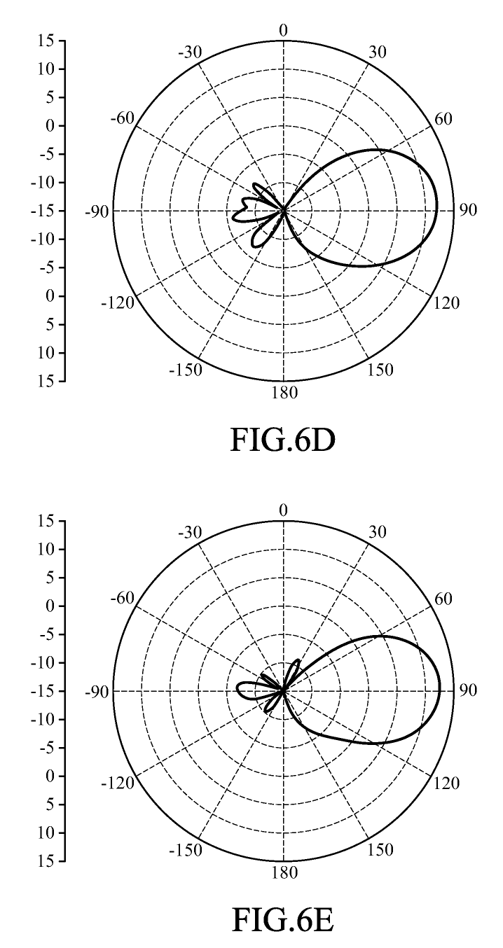

FIGS. 6A, 6B, 6C, 6D, and 6E are field patterns of a central polarization of a vertical plane respectively obtained at frequency values 1710 MHz, 1825 MHz, 1940 MHz, 2055 MHz, and 2170 MHz according to the second embodiment of the present invention.

Referring to Table 1, Table 1 is a measurement table organized with reference to FIGS. 5A-5E and FIGS. 6A-6E. It is seen from Table 1 that the maximum gains of the central polarizations of the vertical plane and the horizontal plane exceed 10 dBi, and the maximum gain increases with the increase of the frequency. Meanwhile, it is seen from Table 1 that the angle of bandwidth (BW) of the vertical plane is above 30°, and the angle of BW of the horizontal plane is above 35°. The angle of BW decreases with the increase of the frequency.

TABLE 1
Measurement table in a frequency range 1710 MHz-2170 MHz

| | Frequency (MHz) | | | | |
|---|---|---|---|---|---|
| | 1710 | 1825 | 1940 | 2055 | 2170 |
| Maximum horizontal gain | 10.0 | 11.5 | 11.1 | 11.7 | 12.4 |
| (dBi) | | | | | |
| Maximum vertical gain (dBi) | 10.1 | 11.2 | 11.5 | 12.1 | 12.4 |
| Horizontal bandwidth | 39.7 | 39.5 | 35.5 | 34.6 | 32.3 |
| (degree) | | | | | |
| Vertical bandwidth (degree) | 47.3 | 44.0 | 44.8 | 38.8 | 35.8 |

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An antenna, comprising:
a substrate, having a surface;
a radiation portions, comprising:
a first radiation unit, disposed on the surface; and
a second radiation unit, disposed on the surface to serve as a ground unit, wherein the second radiation unit and the first radiation unit have a same shape and are symmetrical in position, and the second radiation unit is connected to the first radiation unit, such that the first radiation unit and the second radiation unit form a closed loop; and
a signal feed-in portion, disposed on the first radiation unit, for feeding in/out a signal.

2. The antenna according to claim 1, wherein the first radiation unit has a body.

3. The antenna according to claim 2, wherein the first radiation unit has a plurality of first grooves extending in a direction corresponding to a smallest distance between the outer side of the body of the first radiation unit and the second radiation unit, so as to inhibit an impact of current leakage on the first radiation unit.

4. The antenna according to claim 2, wherein the first radiation unit has a first extension portion and a second extension portion extending from two sides of the body.

5. The antenna according to claim 1, wherein the second radiation unit has a body.

6. The antenna according to claim 5, wherein the second radiation unit has a plurality of second grooves extending in a direction corresponding to a smallest distance between the outer side of the body of the first radiation unit and the second radiation unit, so as to inhibit an impact of current leakage on the first radiation unit.

7. The antenna according to claim 5, wherein the second radiation unit has a third extension portion and a fourth extension portion extending from two sides of the body.

8. The antenna according to claim 1, wherein the first radiation unit and the second radiation unit are M-shaped.

9. An antenna, comprising:
a substrate, having a first surface and a second surface, wherein the first surface has a first circuit, and the second surface has a second circuit overlapping the first circuit;
a main signal feed-in portion, disposed on the first circuit and the second circuit, for feeding in/out a signal;
a plurality of radiation portions, each comprising:
a first radiation unit, disposed on the first surface and electrically connected to the first circuit; and
a second radiation unit, disposed on the first surface to serve as a ground unit, wherein the second radiation unit and the first radiation unit have a same shape and are symmetrical in position, and the second radiation unit is connected to the first radiation unit, such that the first radiation unit and the second radiation unit form a closed loop; and
a plurality of sub-signal feed-in portions, disposed on the second circuit and the first radiation unit, for feeding in/out the signal.

10. The antenna according to claim 9, wherein the first radiation unit has a body.

11. The antenna according to claim 10, wherein the first radiation unit has a plurality of first grooves extending in a direction corresponding to a smallest distance between the outer side of the body of the first radiation unit and the second radiation unit, so as to inhibit an impact of current leakage on the first radiation unit.

12. The antenna according to claim 9, wherein the first radiation unit has a first extension portion and a second extension portion extending from two sides of the body.

13. The antenna according to claim 9, wherein the second radiation unit has a body.

14. The antenna according to claim 13, wherein the second radiation unit has a plurality of second grooves extending in direction corresponding to a smallest distance between the outer side of the body of the first radiation unit and the second radiation unit, so as to inhibit an impact of current leakage on the first radiation unit.

15. The antenna according to claim 9, wherein the second radiation unit has a third extension portion and a fourth extension portion extending from two sides of the body.

16. The antenna according to claim 9, wherein the first radiation unit and the second radiation unit are M-shaped.

17. The antenna according to claim 9, wherein the plurality of radiation portions is distributed in a matrix.
